(19) United States
(12) Patent Application Publication
(10) Pub. No.: US 2013/0075074 A1
(43) Pub. Date: Mar. 28, 2013

(54) Thermal Dissipation Device

(71) Applicant: Kuo-Ching CHIANG, New Taipei City (TW)

(72) Inventor: Kuo-Ching CHIANG, New Taipei City (TW)

(21) Appl. No.: 13/673,518

(22) Filed: Nov. 9, 2012

Related U.S. Application Data
(63) Continuation-in-part of application No. 13/037,361, filed on Mar. 1, 2011.
Application No. 13/037,361 is a continuation-in-part of application No. 11/819,124, filed on Jun. 25, 2007, now abandoned.
Application No. 11/819,124 is a continuation-in-part of application No. 10/900,766, filed on Jul. 28, 2004, now Pat. No. 7,388,549.
Application No. 10/900,766 is a continuation-in-part of application No. 10/898,761, filed on Jul. 26, 2004, now abandoned.
Application No. 10/898,761 is a continuation-in-part of application No. 12/132,277, filed on Jun. 3, 2008.

(51) Int. Cl. F28F 21/02; F28F 3/02

(52) U.S. Cl. CPC F28F 21/02; F28F 3/025; B82Y 99/00
USPC 165/185; 977/752; 977/750; 977/742

(57) ABSTRACT

A thermal dissipation device for an electronic device includes a heat sink having predetermined shape and form for placing over the electronic device, wherein the heat sink includes fins for increase surface area; and carbon nanotubes formed on a surface of the heat sink and the fins to increase the thermal dissipation surface, thereby enhancing thermal dissipation. The carbon nanotubes comprises multi-walled carbon nanotubes (MWNTs), single-walled carbon nanotubes (SWNTs), graphenated carbon nanotubes.

### CROSS-REFERENCE TO RELATED APPLICATION

The application is a continuation in part application of U.S. patent applications with Ser. No. 12/132,277, filed on Jun. 3, 2008 and Ser. No. 13/037,361, filed on Mar. 1, 2011, which is a continuation in part application of Ser. No. 11/819,124, filed on Jun. 25, 2007. The application with Ser. No. 11/819,124 is a continuation in part application of Ser. No. 10/900,766, filed on Jul. 28, 2004, issued on Jun. 17, 2008 (U.S. Pat. No. 7,388,549), and is a continuation in part application of Ser. No. 10/898,761, filed on Jul. 26, 2004, now abandoned.

### FIELD OF THE INVENTION

The present invention relates to a print circuit board, and more particularly, to an improvement of print circuit boards having non-metal pattern.

### BACKGROUND

Recently, the issues of environmental protection is more serious than ever, the greenhouse effect and oil shortage impacts to the earth and global environment, continuously. Because of the issue mentioned above, manufactures endeavor to develop green product such as solar cell to save the energy. Solar cells are a kind of optoelectronic semiconductor device for transforming light into electricity. Conventional thermal transfer occurs only through conduction. Heat transfer associates with carriage of the heat by a substance. Peltier effect is the reverse of the Seebeck effect. When a current is passed through two conductors such as metals or semiconductors (n-type and p-type) connected to each other at two junctions (Peltier junctions), a heat difference is created between the two junctions. Namely, current drives a heat transfer from one junction to the other, one junction cools off while the other heats up. When electrons flow from a region of high density to a region of low density, they expand and cool. The direction of transfer will be changed when the polarity is revised and thus the sign of the heat absorbed/evolved. The effect may transfer heat from one side of the device to the other. When current moves from the hotter end to the colder end, it is moving from a high to a low potential, so there is an evolution of energy. JP 2005-116698A disclosed a bulk device constructing by p and n type semiconductor bulk. All the pluralities of Peltier devices are thick, and is unlikely formed over a substrate of glass or chip package. Obliviously, what is desired is a thinner cooler with energy saving properties.

### SUMMARY OF THE INVENTION

A thermal dissipation device for an electronic device comprises a heat sink having predetermined shape and form for placing over the electronic device, wherein the heat sink includes fins for increase surface area; and carbon nanotubes formed on a surface of the heat sink and the fins to increase the thermal dissipation surface, thereby enhancing thermal dissipation. The carbon nanotubes comprises multi-walled carbon nanotubes (MWNTs), single-walled carbon nanotubes (SWNTs), graphenated carbon nanotubes.

A thermal dissipation device for an electronic device comprises Peltier devices act a heat pump coupled to electrical power; a heat sink located over the Peltier devices for placing over the electronic device, wherein the heat sink includes fins for increase surface area; and carbon nanotubes formed on a surface of the heat sink and the fins to increase the thermal dissipation surface, thereby enhancing thermal dissipation. The carbon nanotubes comprises multi-walled carbon nanotubes (MWNTs), single-walled carbon nanotubes (SWNTs), graphenated carbon nanotubes.

### BRIEF DESCRIPTION OF THE DRAWINGS

FIG. 1 is a sectional view of the present invention.

FIG. 2 is a sectional view of the present invention.

FIG. 3 is a sectional view of the present invention.

FIG. 4 is a sectional view of the present invention.

FIG. 5 is a sectional view of the present invention.

FIG. 6 is a functional diagram of the present invention.

### DETAILED DESCRIPTION OF THE PREFERRED EMBODIMENTS

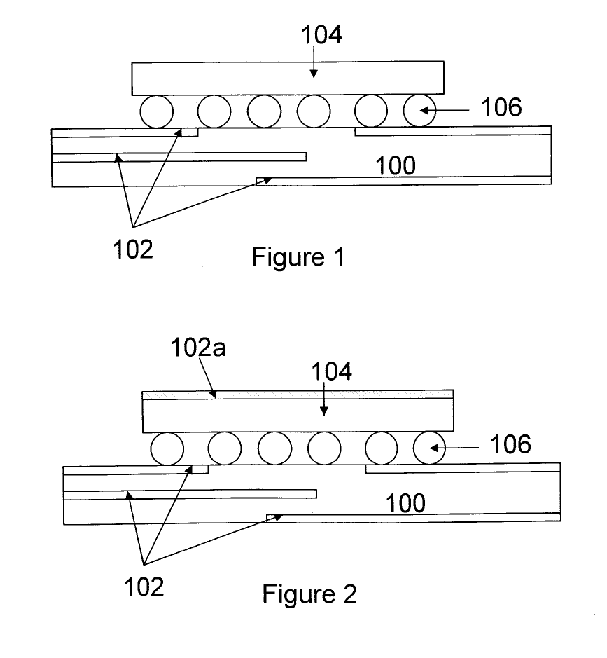

FIG. 1 is a sectional view of a print circuit board of the present invention. As shown in FIG, in the single (or multi) layer print circuit board 100 of the present invention, The PCB 100 includes an insulation substrate having a flat shape is used as a support base. The insulation substrate is made of epoxy resin or glass fiber enhanced epoxy resin. At least one circuit pattern 102 is provided on one of the upper surface or the bottom surface of the insulation substrate. The circuits may be formed within the PCB 100. The prior art includes conductive layer made of copper foils laminated on both the upper surface and the bottom surface of the insulation substrate. After dry films are exposed to an ultraviolet ray through a photomask and are developed by using a water solution of 1% sodium carbonate, they are etched by using a water solution of cupric chloride. The dry films are removed, resulting in the inner circuit pattern. The present invention do not use the conventional method due to it raises drawbacks. An electronic component or device 104 may be formed on the PCB 100 via electronic connection 106. Some of the connections 106 are coupled to the desired circuit pattern 102. The device 104 is illustrated for example only, not to limit the present invention. It should be note that any kind of device can be formed on the PCB. The shape of the connection 106 can be bump, pin and so on.

In one embodiment, the material for the conductive pattern 102 includes oxide containing metal or alloy, wherein the metal is preferable to select one or more metals from Au, Zn, Ag, Pd, Pt, Rh, Ru, Cu, Fe, Ni, Co, Sn, Ti, In, Al, Ta, Ga, Ge and Sb. Some of the transparent material includes oxide containing Zn with Al₂O₃ doped therein. This shape is constructed by using an adequate mask during the forming process of the transparent conducting layer.

The method for forming the transparent conductive layer includes ion beam method for film formation at low temperature, for example, the film can be formed with receptivity lower than 3×10⁻⁴ Ω·cm at room temperature. Further, the RF magnetron sputtered thin film method could also be used. The transparent can be higher than 82%. Under the cost and production consideration, the method for forming the antenna film, for example, indium tin oxide, could be formed at room temperature in wet atmosphere has an amorphous state, a desired pattern can be obtained at a high etching rate. After the film is formed and patterned, it is thermally treated at a temperature of about between 180 degree C. and 220 degree C. for about one hour to three hours to lower the film resistance and enhance its transmittance. Another formation is chemical solution coating method. The coating solution includes particles having an average particle diameter of 1 to 25 μm, silica particles having an average particle diameter of 1 to 25 μm, and a solvent. The weight ratio of the silica particles to the conductive particles is preferably in the range of 0.1 to 1. The conductive particles are preferably metallic particles of one or more metals selected from Au, Zn, Ag, Pd, Pt, Rh, Ru, Cu, Fe, Ni, Co, Sn, Ti, In, Al, Ta, Ga, Ge and Sb. The conductive particles can be obtained by reducing a salt of one or more kinds of the aforesaid metals in an alcohol/water mixed solvent. Heat treatment is performed at a temperature of higher than about 100 degree C. The silica particles may improve the conductivity of the resulting conductive film. The metallic particles are approximately contained in amounts of 0.1 to 5% by weight in the conductive film coating liquid.

The transparent conductive film can be formed by applying the liquid on a substrate, drying it to form a transparent conductive particle layer, then applying the coating liquid for forming a transparent film onto the fine particle layer to form a transparent film on the particle layer. The coating liquid for forming a transparent conductive layer is applied onto a substrate by a method of dipping, spinning, spraying, roll coating, flexographic printing or the like and then drying the liquid at a temperature of room temperature to about 90.degree. C. After drying, the coating film is curing by heated at a temperature of not lower than 100 degree C. or irradiated with an electromagnetic wave or in the gas atmosphere.

Alternatively, the material for forming aforementioned circuits pattern includes conductive polymer, conductive carbon or conductive glue. The non-metal material is lighter weight, cost reduction, eliminates the environment issue and benefits simple process. The conventional PCB is formed of copper or the like. The cost of the copper is high and it is heavy. On the contrary, the present invention employs the non-metallic material to act the circuits pattern for PCB to save the cost and lose weight. The formation of the conductive polymer, conductive carbon or conductive glue may be shaped or formed by printing (such as screen printing), coating, attaching by adhesion or etching. The process is simplified than the conventional one. On the other hand, the thin film can be attached or formed on irregular surface or non-planner surface.

In one embodiment, the material can be formed by conductive polymer, conductive glue or conductive carbon (such as carbon nano-tube; CNT). In one embodiment, the conductive pattern and the blind hole is formed of nano-scale conductive carbon, such as carbon nanotubes (CNTs) that comprises multiple concentric shells and termed multi-walled carbon nanotubes (MWNTs), single-walled carbon nanotubes (SWNTs) that includes a single graphene rolled up on itself, it were synthesized in an arc-discharge process using carbon electrodes doped with transition metals. The seamless graphitic structure of single-walled carbon nanotubes (SWNTs) endows these materials with exceptional mechanical properties: Young's modulus in the low TPa range and tensile strengths in excess of 37 GPa, please refer to the Articles: Yakobson et al., Phys. Rev. Lett. 1996, 76, 2411; Lourie et al., J. Mater. Res. 1998, 13, 2418; lijima et al., J. Chem. Phys. 1996, 104, 2089. Generally, CNT composites interpenetrating nanofiber networks, the networks comprising mutually entangled carbon nanotubes intertwined with macromolecules in a cross-linked polymer matrix. On of the method to form the CNT is the infusion of organic molecules capable of penetrating into the clumps of tangled CNTs, thereby causing the nanotube networks to expand and resulting in exfoliation. Subsequent in situ polymerization and curing of the organic molecules generates interpenetrating networks of entangled CNTs or CNT nanofibers (ropes), intertwined with cross-linked macromolecules.

The conductive polymer includes polythiophenes, poly(selenophenes), poly(tellurophenes), polypyrroles, polyanilines. In one embodiment, the conductive polymer maybe made from at least one precursor monomer selected from thiophenes, selenophenes, tellurophenes, pyrroles, anilines, and polycyclic aromatics. The polymers made from these monomers are referred to herein as polythiophenes, poly(selenophenes), poly(tellurophenes), polypyrroles, polyanilines, and polycyclic aromatic polymers, respectively. U.S. Patent Application 20080017852 to Huh; Dal Ho et al., entitled “Conductive Polymer Composition Comprising Organic Ionic Salt and Optoelectronic Device Using the Same”, it discloses a method of forming conductive polymer. In one embodiment, the conductive polymer is an organic polymer semiconductor, or an organic semiconductor. The conductive polyacetylenes type include polyacetylene itself as well as polypyrrole, polyaniline, and their derivatives. Conductive organic polymers often have extended delocalized bonds, these create a band structure similar to silicon, but with localized states. The zero-band gap conductive polymers may behave like metals.

Alternatively, the circuits pattern of PCB can be formed of conductive glue that can be made of material such as silicon glue or epoxy, etc. The thin film antenna is transparent. In one embodiment, the conductive glue may be formed of the mixture of at least one glass, additive and conductive particles (such as metallic particles). The conductive glue maybe includes aluminum (and/or silver) powder and a curing agent. The glass is selected from Al₂O₃ [symbol] B₂O₃ [symbol] SiO₂ [symbol] Fe₂O₃ [symbol] P₂O₅ [symbol] TiO₂ [symbol] B₂O₃/H₃BO₃/Na₂B₄O₇ [symbol] PbO [symbol] MgO [symbol] Ga₂O₃ [symbol] Li₂O [symbol] V₂O₅ [symbol] ZnO₂ [symbol] Na₂O [symbol] ZrO₂ [symbol] TlO/Tl₂O₃/TlOH [symbol] NiO/Ni [symbol] MnO₂ [symbol] CuO [symbol] AgO [symbol] Sc₂O₃ [symbol] SrO [symbol] BaO [symbol] CaO [symbol] Tl [symbol] ZnO. The additive material includes oleic acid.

Alternatively, the connection 106 of electronic device 104 maybe formed of above material to avoid the environment issue. The material has no lead contained therein. Therefore, the lead-free structure can be provided. Further, the aforementioned conductive material 102a for circuit pattern can be formed on at least one surface of the device 104, for example upper surface, side surface, lower surface to enhance the thermal dissipation as shown in FIG. 2. In the FIG. 2, the electronic device 104 is made by flip-chip scheme which is known in the art. The substrate 104a of the electronic device 104 is the upper surface which contacts with the aforementioned conductive material 102a when the device 104 is mounted on the circuit board. Thus, the device's substrate (upper surface of the electronic device 104) includes the nano-scale conductive material formed thereon to increase the effective surface to enhance the thermal dissipation. The device's substrate includes silicon, metal, alloy, ceramic, glass or isolation as known in the art. Any type of the package can be used to achieve the purpose of the present invention. If the upper surface (device's substrate) 104a of the device 104 is coated with the conductive material 102a having nano-scale dimension, such as the aforementioned CNT, conductive polymer, glue and ITO. The nano-scale material may have more effective surface area than larger scale material to effectively increase the thermal dissipation surface. Further, as mentioned in the abstract of the present invention, the present invention provides a multilayer print circuit board having at least two circuit patterns laminated on a circuit board substrate through an insulation layer and being electrically connected to each other through a blind hole 102b provided in the insulation layer to form an electrical connection. At least one circuit pattern is formed of non-metal material for electrically connection between the conductive layers and the blind hole 102b. If the blind hole is refilled with the polymer, CNT or the ITO, it may easily refilled into the hole to form the electrical connection with air gap or cavity free in the plug due to these materials have the character of flowability above before curing even the dimension is narrowed.

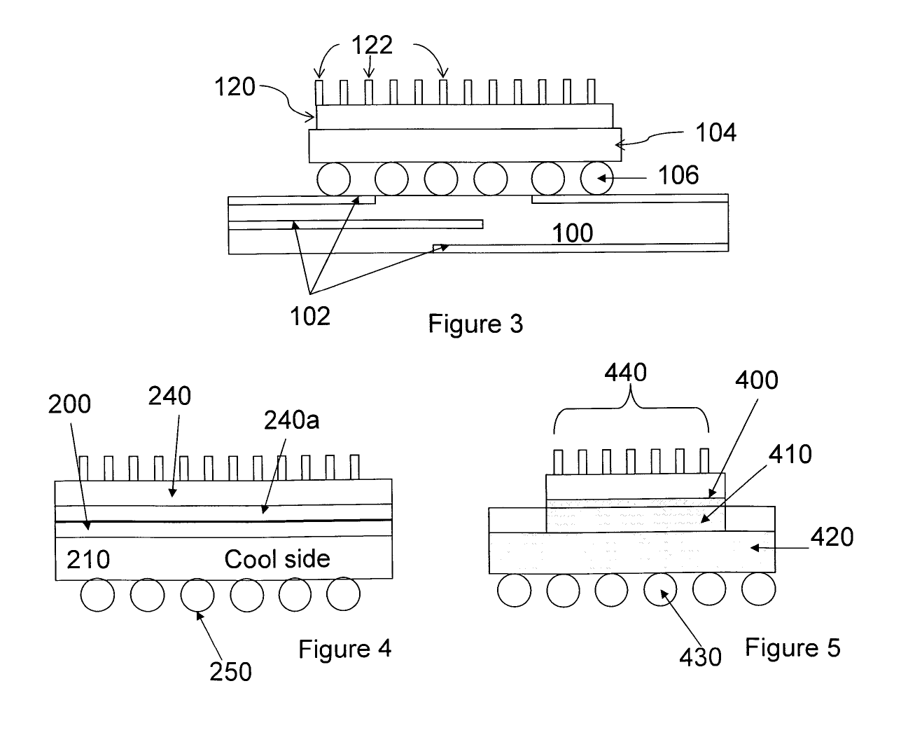

Please refer to FIG. 3, in another embodiment, a heat sink 120 having fins 122 is located over the chip 104. The surface of the heat sink 120 and its fins 122 are coated or print with above CNT or the conductive polymer to improve the efficiency of thermal dissipation. Thus, the heat sink 120 surface includes the nano-scale conductive material with larger surface area than ever formed thereon to significantly increase the effective surface, thereby enhancing the thermal dissipation. Carbon nanotubes (CNTs) are allotropes of carbon with a cylindrical nanostructure. Nanotubes have been constructed with length-to-diameter ratio of up to 132,000,000:1, significantly larger than for any other material. In particular, carbon nanotubes find applications as additives to various structural materials. The heat sink 120 and the fins 122 include silicon, metal, alloy, copper, ceramic or the like. Alternatively, the Graphenated CNTs are introduced in the present invention, it combines graphitic foliates grown along the sidewalls of multiwalled or bamboo style CNTs. Please refer to Yu, Kehan; Ganhua Lu, Zheng Bo, Shun Mao, and Junhong Chen (2011). “Carbon Nanotube with Chemically Bonded Graphene Leaves for Electronic and Optoelectronic Applications”. J. Phys. Chem. Lett. 13 2 (13): 1556-1562. Yu et al.reported on “chemically bonded graphene leaves” growing along the sidewalls of CNTs. The advantage of an integrated graphene-CNT structure is the high surface area three-dimensional framework of the CNTs coupled with the high edge density of graphene. The Helical Multi-Walled Carbon Nanotubes may be introduced in the present invention. Ultrasonic or air spray nozzles are used to spray carbon nanotubes to create homogenous, uniform layers. Since CNTs are prone to agglomerate in solution, nozzles are uniquely well suited to carbon nanotube spray applications, as the ultrasonic vibrations of the nozzle continuously disperse agglomerates in suspension during the coating process. Since the spray coating of SWCNT solution gives the SWCNT-SDS composite layer after drying, the excess SDS should be washed off. The removal of excess SDS was conducted by dipping in the 3 N HNO3 and SOCl2 solution and washing with deionized water followed by heat treatment in a 120 degrees C. convection oven for 30 min. For example, the geometric high aspect ratio is μm length and nm diameter. It improves conventional thermal management systems without new designs. For example, existing heat sinks can obtain a CNT layer by dipping into colloidal solution and drying at atmospheric temperature.

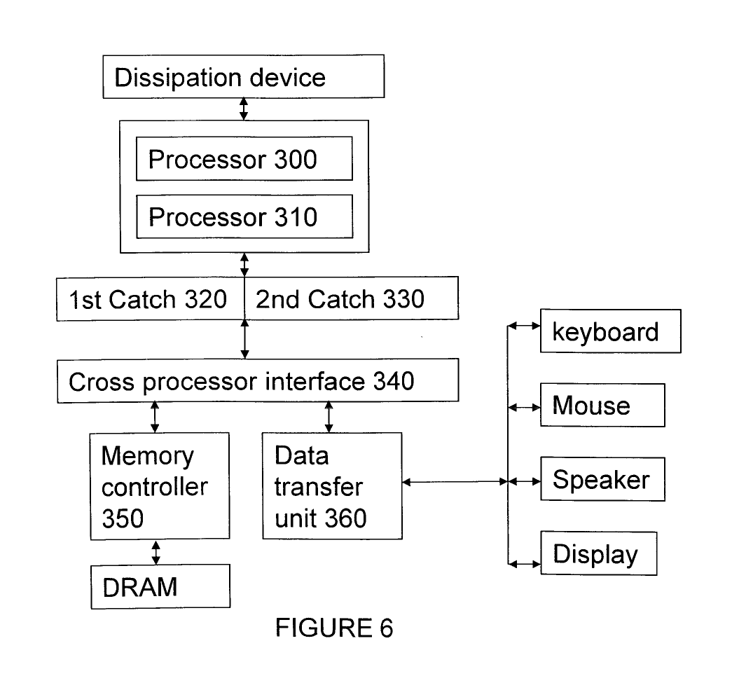

In another embodiment, the Peltier device is used to act the heat pump for processor for computer, notebook, tablet, smart phone or mobile device such as cellar, PDA, GPS. The Peltier diodes 200 is coupled to the semiconductor chip package 210 having die contained therein by the method of FIG. 4. In one case, pluralities of Peltier diodes 200 are coated on the outside of BGA device having conductive balls 250. The flip-chip package is used for illustration only, not limits the scope of the present invention. The chip could be any device such as LED. At least one Peltier diodes 200 is formed on the semiconductor chip package 210. Most of the thermal is generated by the chip or processor of the computer, notebook or mobile device. The Peltier diode 200 can be formed by PVD, CVD, sputtering or coating. In order to improve the performance of thermal dissipation, a heat sink 240 may be attached on the Peltier diode 200 by adhesion or thermal conductive glue 240a. Accordingly, the heat sink is formed on the hot side, therefore, after the electricity is provided to the Peltier diode 200. The current drives a heat transfer from semiconductor component 210 to the heat sink side, one junction cools off while the other heats up. Especially, the scheme may be used to the due processors system, as shown in FIG. 6. In the case, the heat dissipater is formed outside of the semiconductor package assembly. Alternatively, referring to FIG. 5, the heat dissipater 400 is attached over the die 410 on a substrate 420 having conductive balls 430. The heat sink 440 is attached over the heat dissipater 400. In the flip-chip scheme, the heat dissipater 400 may be formed over the backside surface of the wafer before assembly. The backside surface refers to the surface without active area. Please refer to FIG. 6, the electronic system includes a first processor 300 and a second processor 310. A first catch 320 and a second catch 330 are coupled to the first processor 300 and a second processor 310, respectively. Cross process interface 340 is coupled to the first catch 320 and a second catch 330. A memory controller 350 and a data transfer unit 360 are coupled to the cross process interface 340. The cross process interface 340 is used to determine how to transfer the date in/out to/from the first processor 300 and a second processor 310. The DRAM is coupled to the memory controller 350. A plurality of periphery device such as Mic., speaker, keyboard, mouse are coupled to the data transfer unit 360. A fan may be optionally coupled to the heat dissipation device mentioned in FIG. 2. If the system is single chip system, the cross-process interface is omitted. If the system is communication device, RF is necessary. Therefore, the present invention discloses a thermal solution for a computer system including a heat dissipater mentioned above coupled to the CPU to dissipate the thermal generated by the CPU. The embodiments of FIGS. 3, 4 5 may be used along or combination together to further increase the thermal dissipation.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A thermal dissipation device for an electronic device comprising:
a heat sink having a predetermined shape and being placing over said electronic device, wherein said heat sink includes fins for increase surface area; and
carbon nanotubes formed on a surface of said heat sink and said fins to increase the thermal dissipation surface, thereby enhancing thermal dissipation.

2. The thermal dissipation device of claim 1, wherein said carbon nanotubes comprises multi-walled carbon nanotubes (MWNTs).

3. The thermal dissipation device of claim 1, wherein said carbon nanotubes comprises single-walled carbon nanotubes (SWNTs).

4. The thermal dissipation device of claim 1, wherein said carbon nanotubes comprises graphenated carbon nanotubes.

5. A thermal dissipation device for an electronic device comprising:
Peltier devices act a heat pump coupled to electrical power;
a heat sink located over said Peltier devices for placing over said electronic device,
wherein said heat sink includes fins for increase surface area; and
carbon nanotubes formed on a surface of said heat sink and said fins to increase the thermal dissipation surface, thereby enhancing thermal dissipation.

6. The thermal dissipation device of claim 5, wherein said carbon nanotubes comprises multi-walled carbon nanotubes (MWNTs).

7. The thermal dissipation device of claim 5, wherein said carbon nanotubes comprises single-walled carbon nanotubes (SWNTs).

8. The thermal dissipation device of claim 5, wherein said carbon nanotubes comprises graphenated carbon nanotubes.
